(19) United States
(12) Patent Application Publication
(10) Pub. No.: US 2006/0291690 A1
(43) Pub. Date: Dec. 28, 2006

(54) Digital fingerprints and watermarks for images

(76) Inventor: David Keith Roberts, Crawley (GB)

Correspondence Address: PHILIPS INTELLECTUAL PROPERTY & STANDARDS, P.O. BOX 3001, BRIARCLIFF MANOR, NY, 10510, US

(21) Appl. No.: 10/557,630

(22) PCT Filed: May 13, 2004
(86) PCT No.: PCT/IB04/50690

§ 371 Date: Nov. 17, 2005

(30) Foreign Application Priority Data
May 21, 2003 (EP) 03101447.5

(51) Int. Cl. G06K 9/00

(52) U.S. Cl. 382/100

(57) ABSTRACT

A method of dividing an image into grid regions for the application of a watermark or fingerprint uses a calculation of centroid of the image to centre the grid and uses centroids of portions of the image to set the size of the grid.

This invention relates to the application of digital fingerprints and/or watermarks to images.

Video fingerprinting can be used for video content identification and associated applications. It is desirable that the video fingerprint recognition can proceed successfully despite certain distortions to the video content, such as compression, scaling, or translation.

### BACKGROUND

A typical video fingerprint extraction scheme consists of a first stage of extracting features from video frames. Many different features have been proposed for use in generating fingerprints including: DC (mean luminance) values, luminance and/or chrominance histograms, and edges. A common aspect of these schemes is that images are usually divided up into regions (e.g. rectangular blocks) and features extracted for each region. Such a fingerprinting scheme is disclosed in International Patent Application WO-A-02/065782.

The division of an image frame into regions causes recognition problems if the images undergo scaling or translational shifts. The fixed grid used to divide up the image results in image regions containing different content for a scaled/translated image than for the unscaled/unshifted original. This causes differences in the resulting fingerprints that will often prevent the scaled/translated content from being recognised.

It is an object of the present invention to address the above mentioned disadvantages.

According to a first aspect of the present invention a method of applying/detecting a digital fingerprint to/in an image comprises:

dividing the image into regions, the location and size of the regions being based on a content of the image; and applying/detecting the digital fingerprint.

According to a second aspect of the present invention a method of dividing an image into regions for the application/detection of a digital fingerprint comprises selecting the location and size of the regions according to a content of the image.

Preferably, the image is divided based on the location of a centroid of the image. Preferably, a grid for dividing the image is centred substantially at a location of the centroid of the image.

Preferably, horizontal and vertical sizes of divisions of the grid are independent of one another.

Preferably, the size of horizontal and/or vertical divisions is based on a content of portions of the image, preferably based on centroids of portions of the image.

The method advantageously allows a grid location and size to be calculated based on image content, thereby allowing scaling and translation of the image without affecting the watermarking thereof.

The regions may overlap, either horizontally and/or vertically. It has been found that overlapping regions can be used with advantageously better results.

According to a third aspect of the invention a method of embedding/detecting a digital watermark into an image comprises selecting a size and/or location of a watermark pattern based on a content of the image, and applying/detecting the watermark.

Preferably, a location of the watermark, which is preferably present as a grid element, is chosen according to a location of a centroid of the image. Preferably, a size of the watermark, preferably a size of grid for the watermark present as grid elements or in grid elements, is chosen according to a content of portions of the image, preferably centroids of portions of the image.

According to a fourth aspect of the invention there is provided a computing device programmed to operate the method of the first and/or second aspect.

According to a fifth aspect of the invention a computer program product is operable to perform the method of the first and/or the second aspect of the present invention.

All of the features described herein may be combined with any of the above aspects, in any combination.

For a better understanding of the invention and to show how the same may be brought into effect, specific embodiments will now be described, by way of example, with reference to the accompanying drawings, in which:

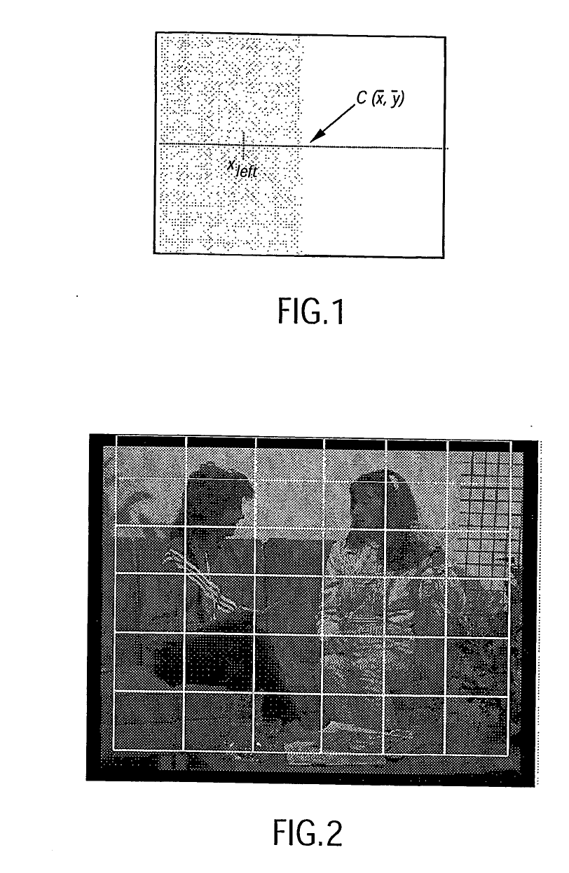

FIG. 1 is a schematic diagram of an image frame showing a centroid;

FIG. 2 is an image having a grid of blocks applied thereto;

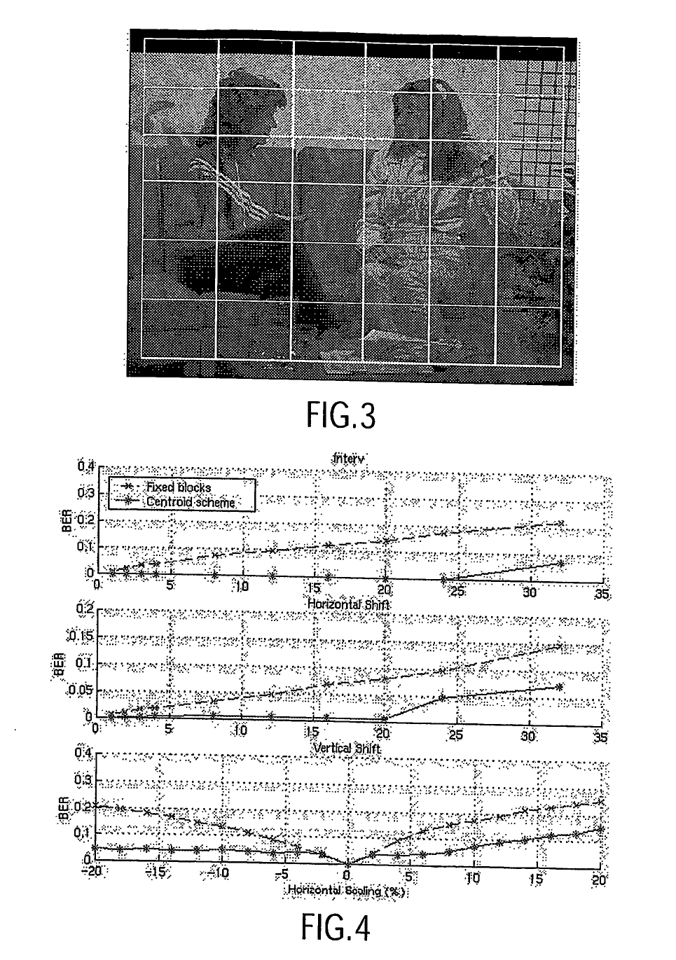

FIG. 3 is the image of FIG. 2, after horizontal scaling and vertical shifting;

FIG. 4 shows bit error rates (BER) for fingerprints of a first example video clip and the same vide clip after scaling/shifting;

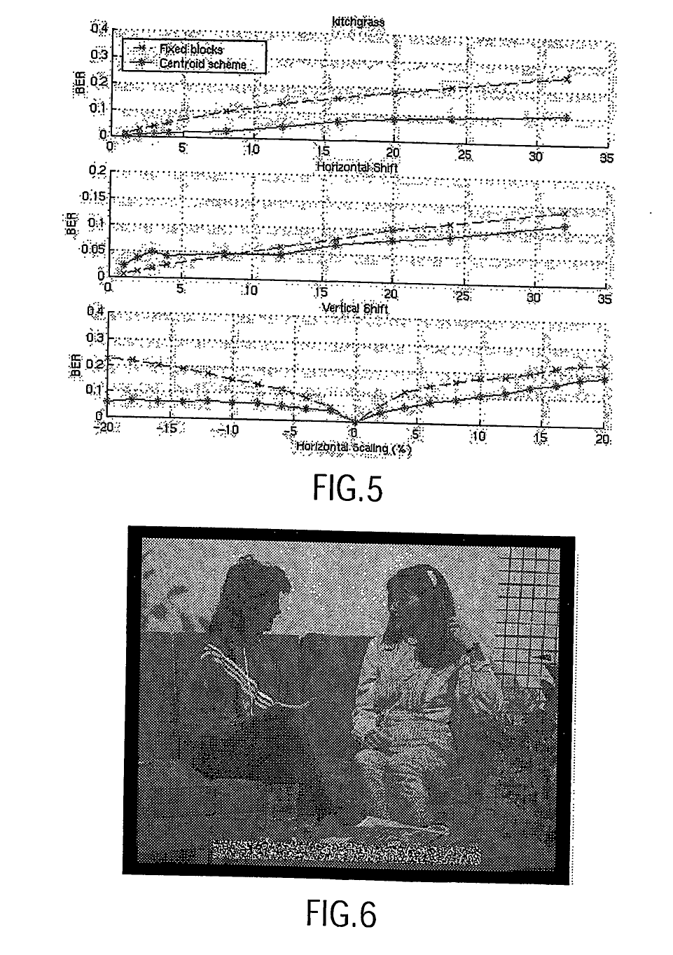

FIG. 5 shows BER for a second example video clip after scaling/shifting;

FIG. 6 shows a sample image with a “subtitle” applied;

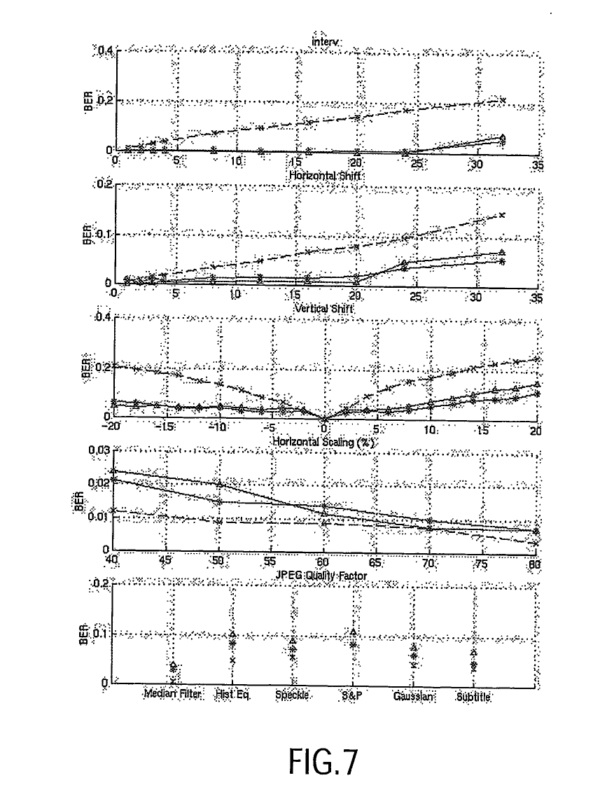

FIG. 7 shows BER for the first example image with a subtitle added; and

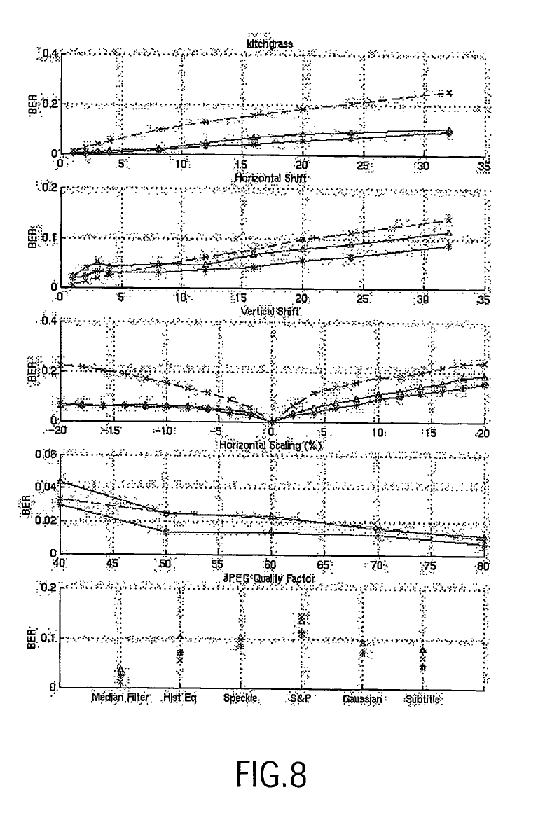

FIG. 8 shows BER for the second example image with a subtitle added

The invention is a technique of deriving fingerprints for image/video content that improves the recognition rate in cases where the content is scaled or translated. It is also described how the same idea can be applied to watermarking in order to help achieve detection in scaled/shifted versions of a watermarked image.

The key idea in this invention disclosure is to divide images into regions in a manner dependent upon the image content itself. In other words, the grid used to divide frames into regions should be determined from the image content. In this way, the grid can be made to scale and shift identically to the image content, resulting in fingerprints for scaled/shifted images that are as close as possible to those of the original images.

A content dependent division of the image can be achieved using centroid (centre of mass) calculations. The centroid of an image region with luminance l(x,y) is the point (\overline{x},\overline{y}) where:

$$\overline{x} = \frac{{\sum }_{x} {\sum }_{y} xI ( x , y )}{{\sum }_{x} {\sum }_{y} I ( x , y )} and \overline{y} = \frac{{\sum }_{x} {\sum }_{y} yI ( x , y )}{{\sum }_{x} {\sum }_{y} I ( x , y )} \\ Note that these can be computed as \text{:}$$

$$\overline{x} = \frac{{\sum }_{x} x {\sum }_{y} I ( x , y )}{{\sum }_{x} {\sum }_{y} I ( x , y )} and \overline{y} = \frac{{\sum }_{y} y {\sum }_{x} I ( x , y )}{{\sum }_{x} {\sum }_{y} I ( x , y )}$$

i.e. the calculation is essentially one dimensional and the number of multiplications can be minimised by (for \overline{x}) summing I(x,y) first over the y direction. The centroid is thus a relatively cheap computation.

The centroid has the property of shifting identically to the image content:

$$\begin{matrix}{\overline{x}}_{shift} = \frac{{\sum }_{x} {\sum }_{y} xI ( x - {x}_{0} , y )}{{\sum }_{x} {\sum }_{y} I ( x - {x}_{0} , y )} \\ = \frac{{\sum }_{{x}^{′}} {\sum }_{y} ( {x}^{′} + {x}_{0} ) I ( {x}^{′} , y )}{{\sum }_{{x}^{′}} {\sum }_{y} I ( {x}^{′} , y )} \\ = \frac{{\sum }_{{x}^{′}} {\sum }_{y} {x}^{′} I ( {x}^{′} , y )}{{\sum }_{{x}^{′}} {\sum }_{y} I ( {x}^{′} , y )} + {x}_{0} \\ = \overline{x} + {x}_{0}\end{matrix}$$

and also of scaling identically to the image content:

$$\begin{matrix}{\overline{x}}_{scale} = \frac{{\sum }_{x} {\sum }_{y} xI ( sx , y )}{{\sum }_{x} {\sum }_{y} I ( sx , y )} \\ = \frac{{\sum }_{{x}^{′}} {\sum }_{y} \frac{1}{s} {x}^{′} I ( {x}^{′} , y )}{{\sum }_{{x}^{′}} {\sum }_{y} I ( {x}^{′} , y )} \\ = \frac{1}{s} \frac{{\sum }_{{x}^{′}} {\sum }_{y} {x}^{′} I ( {x}^{′} , y )}{{\sum }_{{x}^{′}} {\sum }_{y} I ( {x}^{′} , y )} \\ = \frac{1}{s} \overline{x}\end{matrix}$$

These calculations assume that the summations are taken over the entire image content in up-scaled and shifted versions of it. In practice up-scaling and shifting will be combined with cropping in order to preserve the original image dimensions. Cropping involves removing sections of the image from one or more edges to achieve a required ratio of side lengths for the image. This cropping results in errors in the centroid location, which prevents perfect invariance to up-scaling and shifting.

Similarly, down-scaling will in practice be combined with padding with new content (by adding additional data to achieve a required ratio of side lengths) in order to retain the original image dimensions. Scale invariance is still achieved if the padding is made with pixels of value zero, such that they do not contribute in the summations above.

Despite these imperfections in a practical scheme, it will be seen that the centroid shifts and scales sufficiently accurately to achieve considerable robustness in the resulting fingerprints.

Using centroids to provide a scale/shift robust division of the image win be explained for the example of splitting an image into a grid consisting of a number of rectangular blocks. This is desired, for example, by the fingerprint scheme in WO-A-02/065782 the contents of which are incorporated herein by reference, where the DC differences between these blocks are then used to derive the fingerprint bits. The process consists of the following steps:

Calculate the centroid C(\overline{x},\overline{y}) of the whole image—The grid will be centred upon this point, providing robustness to translational shifts of the image Calculate the centroid in the horizontal direction X_{left} of all the image pixels left of C. See FIG. 1.

Calculate also the centroid x_{right} of all image pixels right of C, the centroid y_{above} in the vertical direction of all the image pixels above C, and the centroid y_{below} of all the image pixels below C.

Define block boundaries at:

$$Horizontal direction \text{:}$$

$$\overline{x} - \frac{{ax}_{left} i}{N} , and \overline{x} + \frac{{ax}_{right} i}{N} for i ∈ \{ 0 , 1 , 2 , … , N \}$$

$$Vertical direction \text{:}$$

$$\overline{y} - \frac{{ay}_{below} i}{M} , and \overline{y} + \frac{{ay}_{above} i}{M} for i ∈ \{ 0 , 1 , 2 , … , M \}$$

where a is a multiple chosen to control the total size of the resulting grid of blocks. For example, setting a=2 results in a grid spanning most of the original image, since the centroids of typical image content are usually fairly central. The resulting grid consists of 2M×2N blocks.

In FIG. 1 x_{left} is the centroid in the horizontal direction of the portion of the image left of the total image centroid C(\overline{x},\overline{y})

FIG. 2 shows an example grid of blocks formed using the above procedure for a=2, and M=N=3. FIG. 3 shows the grid formed for the same image scaled horizontally by a factor of 1.1, and shifted vertically by 20 pixels. It can be seen that the image content of each block is similar in both cases, and much more so than if a fixed grid had been used.

The above procedure was used to form blocks from which fingerprints were subsequently derived as in WO-A-02/065782. FIGS. 4 and 5 show the fingerprint bit error rates (BER) between fingerprints of the original video content, and fingerprints from scaled/shifted versions of the same content. For comparison, the fingerprint bit error rates for fixed blocks of 144×80 pixels are also shown; the improvement of the new centroid scheme is clear.

Note that the BERs due to shifts and up-scales are lower for the ‘interv’ video clip in FIG. 4 than they are for the ‘kitchgrass’ clip in FIG. 5. This is because the former has a slightly wider black border at its perimeter. The near-zero intensity values of such a border do not influence the centroid position, thus the BER only begins to rise at larger shifts or up-scales where the effect of cropping begins to take effect. Note also that the BERs for down-scaling are lower than for up-scaling, as expected, as no cropping takes place under down-scaling.

An additional advantage of the presented scheme is that it is robust to different scale factors in the horizontal and vertical directions, i.e. it is robust to aspect ratio changes.

Application to Watermarking

Scaling and shifting of an image can also prevent detection of a watermark contained in that image. Suppose, as in many watermarking schemes (see WO-A-99/45705, for example), that the watermark pattern can be formulated as a tile of noise samples in the spatial domain. This watermark pattern is added to the original image in order to create the watermarked image. The invention presented above allows the size and shift of the embedded watermark pattern to be set by properties of the image content itself (e.g. centroids). The watermark detector can automatically find the appropriate scale and shift of the watermark pattern in the received image by repeating the procedure.

In practice, watermark detection is typically very sensitive to scaling, and the accuracy of the scaling indicated by (e.g.) the centroids may not be great enough to allow detection of the watermark. The invention does, however, provide a first estimate of the scale factor, and this can be used to reduce the number of scale factors that need to be searched in order to detect the watermark. Thus the invention can still provide an advantage in terms of reduced computation in the watermark detector.

The method can be applied equally well to the application or detection of a fingerprint or watermark.

Further Experiments

This section describes further experiments concerning the above centroid based scheme for improved scale and shift robustness.

Subtitles

The addition of a subtitle to a video clip adds areas of bright white pixels to the bottom of the images. Experiments were performed to assess whether this disturbs the centroid positions sufficiently to cause a significant BER increase when matching fingerprints.

Subtitles were ‘simulated’ by adding high density ‘salt and pepper’ noise in the area where subtitles would be added. An example is shown at FIG. 6:

This was found to cause a BER of around 7% for the centroid scheme compared to around 4% for the original scheme of fixed blocks. The position and size of the grid was found to be only slightly affected by the addition of the ‘subtitle’. The minimal impact of the subtitle is simply due to it being only a small fraction of the total number of image pixels: in these experiments the subtitle occupied 5% of the image height, and 60% of the image width, i.e. only 3% of pixels.

Overlapping Blocks

The robustness to shifts and scaling is highly dependent upon the size of the blocks used in calculating the DC differences. This is true for both the fixed block and centroid schemes. In order to increase the effective size of blocks an overlap was introduced as follows:

Each block is extended horizontally such that it covers 50% of each block either side, and likewise vertically. For blocks at the perimeter of the image, the extension is made just to the image edge

A hanning window is applied to the pixel values of the extended block The DC is calculated

The danger of overlapping the blocks is that each pixel contributes to multiple fingerprint bits, and this may increase the correlation between them. If the fingerprint bits from a given frame are correlated then they contain redundancy, i.e. we effectively have fewer fingerprint bits, which will lead to higher false positive rates (matching fingerprints from different content). The above overlap method was found to generate fingerprints which still appeared very similar to those of the non-overlapping blocks. From this it seems reasonable to assume that the resulting fingerprints will still be sufficiently discriminating between different content.

The fingerprint matching results for the usual set of attacks are shown at FIGS. 7 and 8 for two example video clips (dashed line with stars: fixed non-overlapping blocks, solid line with triangles: centroid scheme with non-overlapping blocks, solid line with stars: centroid scheme with overlapping blocks). It can be seen that the overlap of blocks resuts in similar or slightly improved BER in all cases.

1. A method of applying/detecting a digital fingerprint to/in an image comprises:
dividing the image into regions, the location and/or size of the regions being based on a content of the image; and
applying/detecting the digital fingerprint.

2. A method of dividing an image into regions for the application of a digital fingerprint comprises selecting the location and/or size of the regions according to a content of the image.

3. A method of as claimed in claim 1, in which the image is divided based on the location of a centroid of the image.

4. A method as claimed in claim 3, in which a grid for dividing the image is centred substantially at a location of the centroid of the image.

5. A method as claimed in claim 4, in which horizontal and vertical sizes of divisions of the grid are independent of one another.

6. A method as claimed in claim 5, in which the size of horizontal and/or vertical divisions is based on a content of portions of the image.

7. A method as claimed in claim 6, in which the size of horizontal and/or vertical divisions is based on centroids of portions of the image.

8. A method of embedding/detecting a digital watermark into/in an image comprises selecting a size and/or location for a watermark pattern based on a content of the image, and embedding/detecting the watermark.

9. A method as claimed in claim 8, in which a location of the watermark is chosen according to a location of a centroid of the image.

10. A method as claimed in claim 9, in which the watermark is present as a grid element.

11. A method as claimed in claim 10, in which, a size of the watermark or a size of grid for the watermark is chosen according to a content of portions of the image.

12. A method as claimed in claim 11, in which a size of the watermark or a size of grid for the watermark is chosen according to centroids of portions of the image.

13. A computing device programmed to operate the method of claim 1.

14. A computer program product operable to perform the method of claim 1.
